(19) United States
(12) Patent Application Publication
(10) Pub. No.: US 2008/0292752 A1
(43) Pub. Date: Nov. 27, 2008

(54) Manufacturing Method of Soybean Paste by Protease and Its Processed Products

(75) Inventors: Chi-kwang Song, Daejeon (KR); Eun-seok Jang, Choongcheongnam-do (KR); Seung-jin Lee, Choongcheongnam-do (KR); Jong-myon Park, Choongcheongnam-do (KR); Yeong-il Chang, Daejeon (KR); Hee-kyoung Park, Seoul (KR); Mi-young An, Choongcheongnam-do (KR); Jun-bong Choi, Seoul (KR)

Correspondence Address: SWANSON & BRATSCHUN, L.L.C., 8210 SOUTHPARK TERRACE, LITTLETON, CO, 80120, US

(73) Assignee: CJ CHEILJEDANG CORPORATION, Seoul (KR)

(21) Appl. No.: 12/096,715

(22) PCT Filed: Dec. 22, 2006
(86) PCT No.: PCT/KR2006/005660

§ 371 Date: Jun. 25, 2008

(30) Foreign Application Priority Data
Dec. 30, 2005 (KR) 10-2005-0134941

(51) Int. Cl. A23L 1/20

(52) U.S. Cl. 426/46; 426/634

(57) ABSTRACT

The present invention relates to a medium composition comprising fermented Korean hot pepper paste, undiluted solution of brewed soy sauce or acid hydrolyzed soy sauce, and a method for producing gamma-aminobutyric acid (GABA) using the medium. More precisely, the present invention relates to a medium composition for culturing lactobacillus having GAD activity, the composition comprising fermented hot pepper paste, brewed soy sauce or acid hydrolyzed soy sauce, and a method for producing a high concentration of gamma-aminobutyric acid from the medium additionally added with glutamic acid or glutamate. The present invention provides a method of producing a high concentration of gamma-aminobutyric acid using the above medium with low production costs. Since the by-products of pastes are used as medium compositions, this medium itself can be added to other pastes or foods to produce functional foods containing gamma-aminobutyric acid.

### TECHNICAL FIELD

The present invention relates to a method of manufacturing soybean paste by adding a protease to the soybean paste, and more precisely, a method of manufacturing soybean paste comprising the step of adding a protease which has excellent capability of degrading a protein in order to promote aging of the soybean paste, thereby producing a high quality soybean paste, and a soybean paste prepared by the same.

### BACKGROUND ART

Methods of manufacturing soybean paste are largely divided into a traditional method and a improved modern method. According to the traditional method, though it differs between provinces, soybeans are basically steamed, ground, and molded into a brick, rectangle or spherical shape, followed by drying for 2˜3 days. Then, once cracks are observed on the surface, the molded and dried fermented soybeans are tied up and suspended with straw at a suitable temperature and humidity. Then, various natural microorganisms adhere and proliferate thereon. Next, the fermented soybeans are washed clean and soaked in salt water in February or March, followed by fermentin g and aging for 6˜12 months. The resultant solution is boiled down into soy sauce and the remaining solid becomes soybean paste. That is, after separating soy sauce, the remaining solid is a general form of the traditional soybean paste, which contains more salts (salinity: 8.6˜17.8%) and exhibits a different flavor and qualities of water-soluble components such as nitrogen and saccharides, as compared with the improved soybean paste prepared from the entire mixture without separating soy sauce by the modern method.

According to the traditional method, the soybean paste is aged by microorganisms naturally inoculated without selection of a superior strain, so protein degradation might be weak and contamination by harmful bacteria happens frequently, resulting in consistent flavor and low yield, which is not suitable for mass-production.

According to a generally improved industrial method of manufacturing soybean paste, Koji mold(Aspergillus oryzae; A oryzae) as a pure single strain which is a kind of mold is used as a master seed and inoculated into soybeans, rice and wheat flour for fermentation. There is another modified way to manufacture soybean paste, in which Bacillus Subtilis which is a kind of bacillus except Koji mold is used alone or together with Aspergillus oryzae. Most recently, in addition to the Bacillus Subtilis and Aspergillus oryzae, yeast and lactobacillus are separately cultured and inoculated into soybeans.

During the fermentation process after molding, A. oryzae grows on the surface of the molded fermented soybean, while Bacillus grows inside the fermented soybeans to produce a protease which degrades the protein of the soybeans into peptides and amino acids, generating the unique tastes and flavors of the traditional soybean paste. But this processes have the short coming that the soybean paste is aged by microorganisms naturally inoculated without selection of a superior strain, so protein degradation might be weak and contamination by harmful bacteria happens frequently, resulting in consistent flavor and low yield.

To solve the above problem, Korean Patent No. 10-0369218 (Method for the Rapid making of Traditional Soybean Paste by Mixed Fermentation Process) describes that soybean paste(cheong-guk-jang) prepared by Bacillus, which previously grew inside traditional fermented soybeans, is used as a starter, to which Aspergillus oryzae, Zygosaccharomyces rouxii and yeast autolyzate are added independently or together to age the soybean paste with the flavor of traditional fermented soybean. In the meantime, Korean Patent Publication No. 10-2005-0068750 (Manufacturing Method for High Production of peptidase from Maeju and Soysauce) describes that fermented soybeans brick with increased surface area due to pores provide a suitable conditions for the growth of the mold and bacillus, so the level of an enzyme therein is increased, resulting in a significant reduction of fermentation and aging time for the fermented soybeans.

However, the conventional method has the disadvantage of being a troublesome process for culturing and inoculating a strain and preventing the fermented soybeans from being contaminated by other strains during culturing, in addition to the technical problem that the strain does not produce enough protease by mutation of the strain during storage.

### DISCLOSURE OF INVENTION

### Technical Problem

It is an object of the present invention, in order to overcome the above problems of the conventional method, to provide a method of manufacturing soybean paste which is characterized by adding a protease to accelerate aging and enhancing the quality of the soybean paste.

It is another object of the present invention to provide a soybean paste prepared by the same method, added with a protease.

### Technical Solution

To achieve the above objects, the present invention provides a method of manufacturing soybean paste comprising the steps of molding, fermenting, and soaking soybeans, separating them from soy sauce, and adding a protease into them. According to the method of manufacturing soybean paste of the present invention, the protease is at least one or more enzymes selected from a group consisting of those proteases respectively originating from Aspergillus oryzae, Bacillus spp., pineapple and papaya.

The present invention also provides a soybean paste prepared by the method of the present invention comprising the steps of molding, fermenting, and soaking soybeans, separating them from soy sauce, and adding a protease into them.

Hereinafter, the present invention is described in detail.

The present invention provides a method of manufacturing soybean paste comprising the steps of molding, fermenting, and soaking soybeans, separating them from soy sauce, and adding a protease into them.

According to the method of manufacturing soybean paste of the present invention, the protease is at least one or more enzymes selected from a group consisting of those proteases respectively originating from Aspergillus oryzae, Bacillus spp., pineapple and papaya.

The present invention also provides a soybean paste prepared by the method of the present invention comprising the steps of molding, fermenting, and soaking soybeans, separating them from soy sauce, and adding a protease into them.

The proteaseoriginating from Aspergillus oryzae may be Promod 279P.

The proteaseoriginating from Bacillus spp. may be Deliolase or Maxazyme NMP DS.

The proteaseoriginating from pineapple may also be Collupulin MG. The proteaseoriginating from papaya may also be Bromelain.

In the present invention, a single protease or a protease complex prepared by mixing at least two different proteases selected from a group consisting of proteases originating from Aspergillus oryzae, Bacillus spp., papaya and pineapple can be used.

The preferable content of such enzyme in the soybean paste is 0.001˜10%.

The present inventors tried to shorten the aging period of the soybean paste without losing the unique flavor. The unique tastes and flavors of the traditional soybean paste is generated in the course of Aspergillus oryzae growing on the surface of the fermented soybeans and Bacillus spp. growing inside the fermented soybeans during fermentation after molding, and thereby protease is generated to degrade the protein of the soybeans into peptides and amino acids.

According to the present invention, at least one or more proteases selected from a group consisting of proteasesoriginating from Aspergillus oryzae, having excellent protein degradation capacity; Bacillus spp.; and abstracts of plant such as papaya and pineapple are added to the fermented soybeans by 0.001˜10%, which results in shortening the aging period and secures the unique flavor.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a flow diagram illustrating the process of manufacturing traditional soybean paste according to the conventional method.

FIG. 2 is a flow diagram illustrating the process of manufacturing traditional soybean paste according to the present invention.

FIG. 3 is a graph illustrating the results of sensory evaluation on the aged fermented soybeans with an enzyme added.

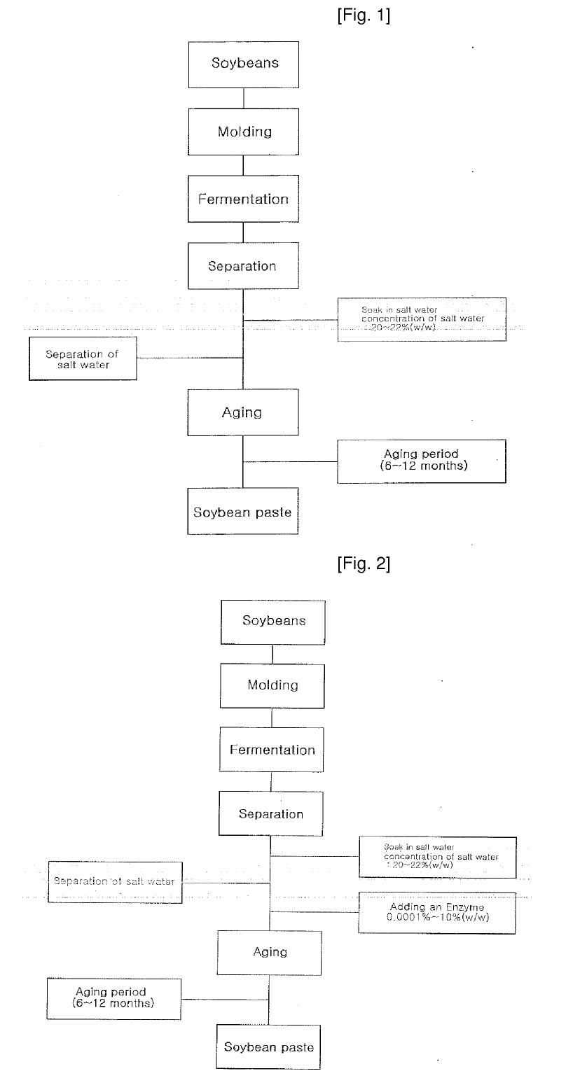

A: control

B: Collupulin MG (the protease originating from papaya)

C: Maxazyme NMP DS (the protease originating from Bacillus spp.)

### BEST MODE FOR CARRYING OUT THE INVENTION

Hereinafter, the embodiments of the present invention will be described in detail with reference to the accompanying drawings. However, these embodiments are not meant to limit the scope of the present invention.

### Example 1

### Preparation of Soybean Paste with a Reduced Aging Period

Soybeans were molded, dried and fermented according to the conventional method, followed by soak in 20˜25% salt water for 90 days. Then, the fermented soybeans were separated from salt water and ground. As shown in Table 1, enzymes were added to the fermented soybeans by 5%, followed by aging for 40 days. The enzymes added hereto were a protease originating from Aspergillus spp. (Promod 279P; Biocatalysts, England), and a protease originating from Bacillus spp. (Delvolase; DSM Food Specialties, Netherlands and Maxazyme NMP DS; DSM Food Specialties, Netherlands). As a result, the maturity of the soybean paste added with the enzyme increased to 191˜339 [symbol] % in the enzyme added soybean paste, as compared with the control.

TABLE 1
The maturity according to the addition of protease originating from
Aspergillus spp. and protease originating from Bacillus spp. to the
soybean paste separated from salt water (Unit: maturity mg %)

| | 0 day | 15 days | 30 days | 45 days |
|---|---|---|---|---|
| Control | 114 | 130 | 196 | 186 |
| Promod 279P | 109 | 259 | 358 | 463 |
| Delvolase | 117 | 187 | 257 | 377 |
| Maxazyme | 111 | 267 | 419 | 525 |
| NMP DS | | | | |

### Example 2

### Preparation of Soybean Paste with a Reduced Aging Period

Soybeans were molded, dried, and fermented according to the conventional method, followed by soak in 20˜25% salt water for 90 days. Then, the fermented soybeans were separated from salt water and ground. As shown in Table 2, enzymes were added by 3% to the fermented soybeans, followed by aging for 50 days. The enzymes used herein were a protease originating from papaya(Collupulin MG); a protease originating from pineapple(Bromelain 1200GDU; Great Food, Thailand), and a protease originating from Aspergillus spp. (Promod 279P; Biocatalysts, England). As a result, the maturity of the soybean paste added with the enzyme increased to 230˜268 [symbol] % in the enzyme added soybean paste, as compared with the control. The protease activity of the enzyme in the soybean paste increased by 52˜87% as compared with the control.

TABLE 2
Results of the addition of the plant protease and the protease
complex to the soybean paste separated from salt water

| Sample | Moisture (%) | Maturity (mg %) | pH | Protease |
|---|---|---|---|---|
| Control | 54.85 | 232 | 5.20 | 13 |
| Collupulin MG | 54.26 | 462 | 5.40 | 65 |
| Bromelain | 53.95 | 479 | 5.85 | 80 |
| Promod | 53.45 | 500 | 5.78 | 100 |
| 279P + Bromelain | | | | |

Control: control group
Collupulin MG: plant protease originating from papaya
Bromelain: plant protease originating from pineapple
Promod 279P: protease originating from Aspergillus spp.

### Example 3

### Results of the Sensory Evaluation of the Prepared Soybean Paste with Reduced Aging Period

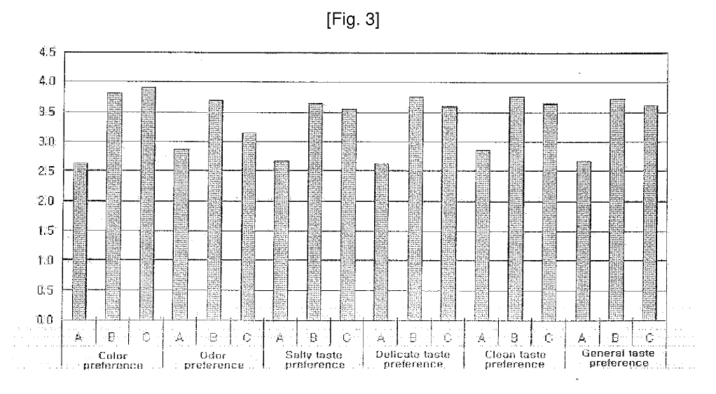

Soybeans were molded, dried, and fermented according to the conventional method, followed by soak in 20˜25% salt water for 80 days. Then, the fermented soybeans were separated from salt water and ground. The enzymes shown in Table 2 were added by 3%, followed by aging for 60 days. Group A was a control, Group B was a protease originating from papaya(Collupulin MG), and Group C was a protease originating from Bacillus Subtilis(Maxazyme NMP DS). Upon completion of aging, each soybean paste (control, papaya protease added group, Bacillus protease added group) was given to examiners composed of 5 males and 5 females (20s˜40s) to investigate color preference, odor preference, salty taste preference, delicate taste preference, clean taste preference, and general taste preference. As shown in FIG. 3, the Collupulin MG added group and Maxazyme NMP DS added group were evaluated as being superior to the control. A 5 point scale was used and the results are shown in FIG. 3 (5 points: excellent, 4 points: good, 3 points: average, 2 points: bad and 1 point: very bad).

### Example 4

### Analysis of the Amino Acid Composition of the Prepared Soybean Paste with Reduced Aging Period

Soybeans were molded, dried, and fermented according to the conventional method, followed by soak in 25% salt water for 90 days. Then, the fermented soybeans were separated from salt water and ground. The enzymes shown in Table 2 were added by 5%, followed by aging for 45 days. As Group A was added the plant protease originating from papaya (Collupulin MG; DSM Food Specialties, Netherlands), as Group B was added the plant protease originating from pineapple (Bromelain 1200GDU; Great Food, Thailand), as Group C was added the protease originating from Aspergillus oryzae (Promod 279P; Biocatalysts, England), as Group D was added the protease originating from Bacillus (Delvolase; DSM Food Specialties, Netherlands), as Group E was added the protease originating from Bacillus (Maxazyme NNP DS; DSM Food Specialties, Netherland) and Group F was a control. The total amount of amino acid in each of the soybean pastes was 24,157˜57,899 ppm higher than that in the control.

TABLE 3
Analysis of amino acid composition (unit: ppm)

| Experimental | | | | | | Control |
|---|---|---|---|---|---|---|
| group | Enzyme added experimental group | | | | | group |
| Amino acid | A | B | C | D | E | F |
| Alanine | 1,965 | 1,947 | 3,297 | 4,589 | 3,804 | 536 |
| Sarcosine | | | | 218 | 60 | |
| Glycine | 704 | 572 | 1,016 | 2,841 | 2,399 | 125 |
| α-Aminobutyric | | | | | | |
| acid | | | | | | |
| Valine | 1,612 | 1,781 | 1,989 | 4,653 | 3,822 | 297 |
| β-Aminobutyric | | | | | | |
| acid | | | | | | |
| IS-Norvaline | | | | | | |
| Leucine | 3,940 | 3,671 | 3,397 | 6,575 | 5,310 | 773 |
| Allo-isolducine | | | | | | |
| Isoleucine | 1,480 | 1,656 | 1,766 | 3,944 | 3,282 | 265 |
| Threonine | 1,194 | 1,253 | 1,538 | 3,867 | 3,104 | 268 |
| Serine | 1,150 | 1,417 | 2,072 | 5,568 | 4,608 | 237 |
| Proline | 1,304 | 1,524 | 1,445 | 4,308 | 3,729 | 312 |
| Aspartic Acid | 1,054 | 1,675 | 1,913 | 8,398 | 6,679 | 251 |
| Methionine | 272 | 272 | 337 | 1,049 | 847 | 108 |
| 4- | | | | | | |
| Hydroxyproline | | | | | | |
| Glutamic Acid | 5,111 | 5,767 | 6,654 | 9,816 | 9,428 | 1,699 |
| Phenylalanine | 2,378 | 2,224 | 1,987 | 3,638 | 3,021 | 482 |
| α-aminoadipic | | | | | | |
| acid | | | | | | |
| Ornithine | 233 | 219 | 509 | | | 139 |
| Lysine | 2,745 | 2,360 | 1,778 | 3,306 | 2,909 | 518 |
| Histidine | 426 | 398 | 250 | 788 | 760 | 51 |
| Tyrosine | 1,017 | 1,159 | 397 | 532 | 329 | 129 |
| Cysline | | | | | | |
| SUM | 26,585 | 27,895 | 30,346 | 64,088 | 54,091 | 6,189 |

A: Collupulin MG, plant protease originating from papaya
B: Bromelain, plant protease originating from pineapple
C: Promod 279P, protease originating from Aspergillus oryzae
D: Delvolase, protease originating from Bacillus
E: Maxazyme NMP DS, protease originating from Bacillus
F: Control, control group

### INDUSTRIAL APPLICABILITY

As explained above, the present invention provides a method of manufacturing soybean paste which is characterized by the addition of a protease with excellent protein degradation capacity during the soybean paste manufacturing process, by which the aging time is shortened and thus production efficiency is increased, without changing the unique tastes and excellent flavors of soybean paste.

1. A method of manufacturing soybean paste, wherein the method comprises the steps of molding, fermenting and socking soybeans in water, separating soy sauce from the fermented soybeans, and adding a protease to the fermented soybeans.

2. The method of manufacturing soybean paste according to claim 1, wherein the protease is at least one or more enzymes selected from a group consisting of proteases respectively originating from Aspergillus oryzae, Bacillus spp., pineapple and papaya.

3. The method of manufacturing soybean paste according to claim 2, wherein the protease originating from Aspergillus oryzae is Promod 279P.

4. The method of manufacturing soybean paste according to claim 2, wherein the protease originating from Bacillus spp. is Delvolase or Maxazyme NMP DS.

5. The method of manufacturing soybean paste according to claim 2, wherein the protease originating from papaya is Collupulin MG.

6. The method of manufacturing soybean paste according to claim 2, wherein the protease originating from pineapple is Bromelain.

7. A soybean paste containing a protease, prepared by the method of claim 1.
